(19) United States
(12) Patent Application Publication
(10) Pub. No.: US 2006/0176391 A1
(43) Pub. Date: Aug. 10, 2006

(54) Digital video recorder

(76) Inventor: Yi-Jen Cheng, Taichung (TW)

Correspondence Address: DELLETT & WALTERS, P. O. BOX 82788, PORTLAND, OR, 97282-0788, US

(21) Appl. No.: 11/052,974

(22) Filed: Feb. 7, 2005

(51) Int. Cl. H04N 5/225; H04N 5/91

(52) U.S. Cl. 348/372; 386/117

(57) ABSTRACT

A digital video recorder has a casing, multiple signal jacks, a circuit board, a power circuit and multiple power jacks. The signal jacks are attached to the casing. The circuit board is mounted inside the casing and is electrically connected to the signal jacks. The power supply circuit is mounted on the circuit board. The power jacks are attached to the casing and are electrically connected to the power supply circuit on the circuit board. Accordingly, the digital video recorder can supply electrical power to the cameras connected thereto so as to incur a low cost for setting a video system up.

### BACKGROUND OF THE INVENTION

1. Field of the Invention

The present invention relates to a digital video recorder (DVR), and more particularly to a digital video recorder that can provide electrical power to cameras connected thereto.

2. Description of Related Art

With reference to FIG. 4, a video system comprises multiple cameras (50), a digital video recorder (40) and at least one monitor (70). The cameras (50) are mounted respectively on multiple locations to take video at the locations. The digital video recorder (40) is electrically connected to the cameras (50) and the monitors (70) to receive video signals from the cameras (50) and send the signals to the monitors (70), such that the user can monitor these locations.

However, for the cameras (50) to operate normally, electrical power must be applied to each camera (50), therefore multiple external power supplies (60) are needed and are electrically connected respectively to the cameras (50). Consequently, more power supplies (60) are needed as more cameras (50) are set, such that to set up a conventional video system is troublesome and expensive.

To overcome the shortcomings, the present invention tends to provide a digital video recorder to mitigate or obviate the aforementioned problems.

### SUMMARY OF THE INVENTION

The main objective of the invention is to provide a digital video recorder that can supply electrical power to the cameras connected thereto so as to reduce the cost for setting up a video system. The digital video recorder has a casing, multiple signal jacks, a circuit board, a power circuit and multiple power jacks. The signal jacks are attached to the casing. The circuit board is mounted inside the casing and is electrically connected to the signal jacks. The power supply circuit is mounted on the circuit board. The power jacks are attached to the casing and are electrically connected to the power supply circuit on the circuit board.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a digital video recorder in accordance with the present invention;

FIG. 2 is a system diagram of a video system with the digital video recorder in FIG. 1;

FIG. 3 is a circuit diagram of the power supply circuit of the digital video in FIG. 1; and

FIG. 4 is a system diagram of a conventional video system in accordance with the prior art.

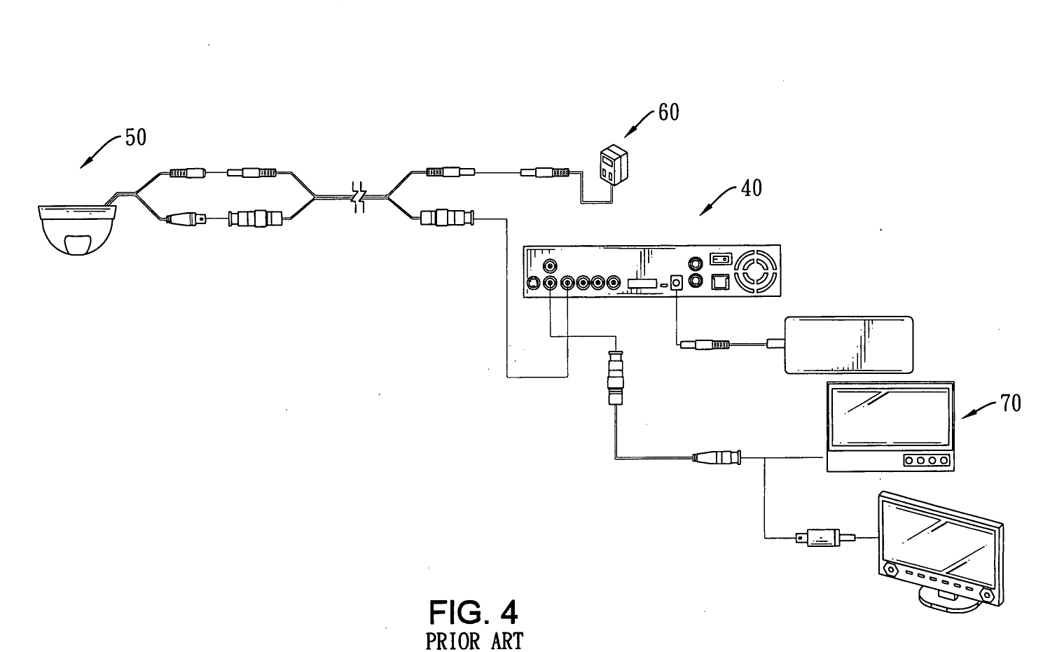

### DETAILED DESCRIPTION OF PREFERRED EMBODIMENT

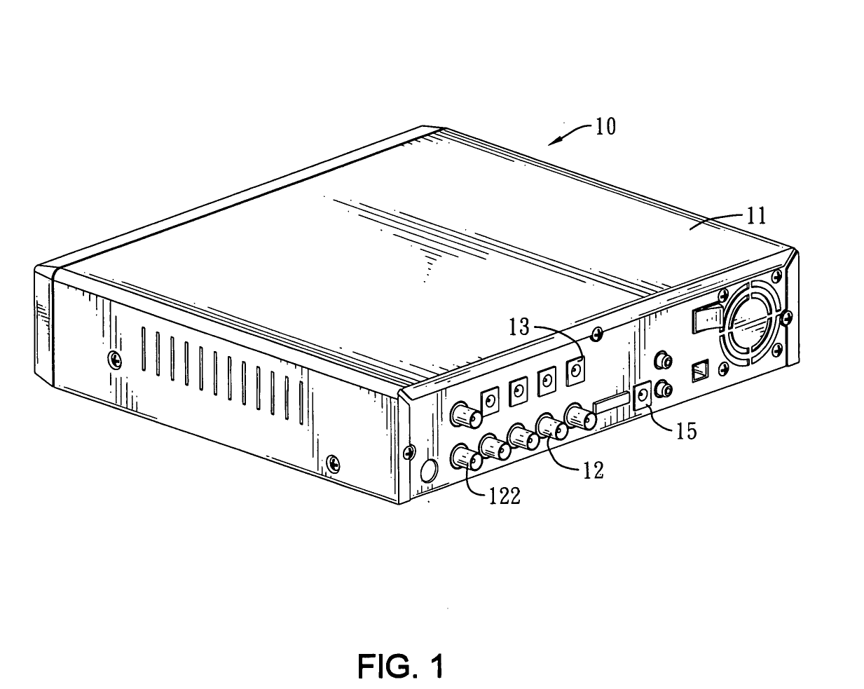

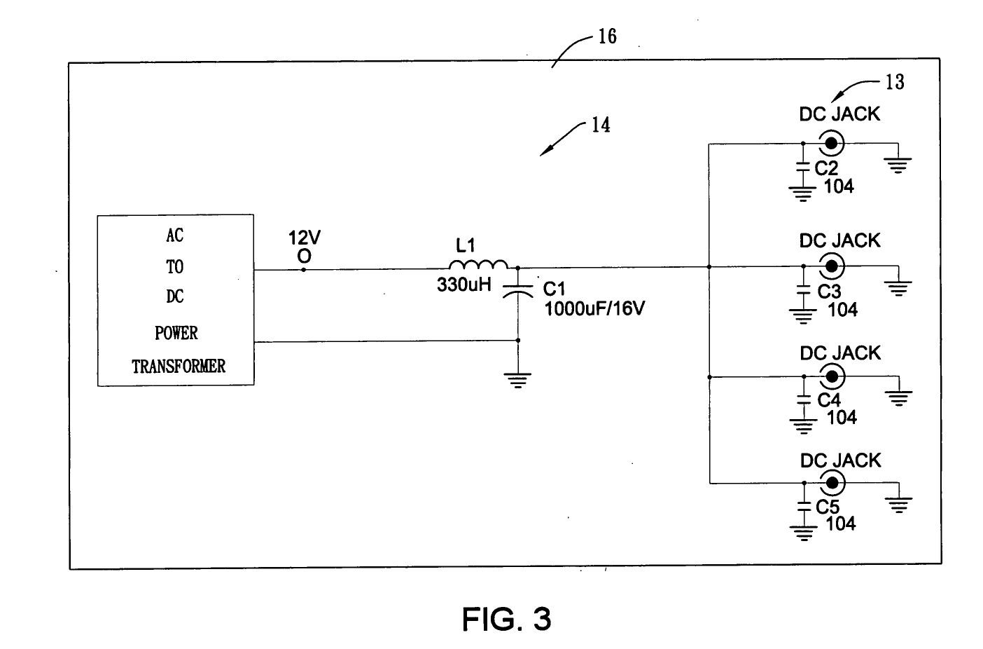

With reference to FIGS. 1 and 3, a digital video recorder (10) in accordance with the present invention comprises a casing (11), multiple signal jacks (12,122), a circuit board (16), a power supply circuit (14) and multiple power jacks (13).

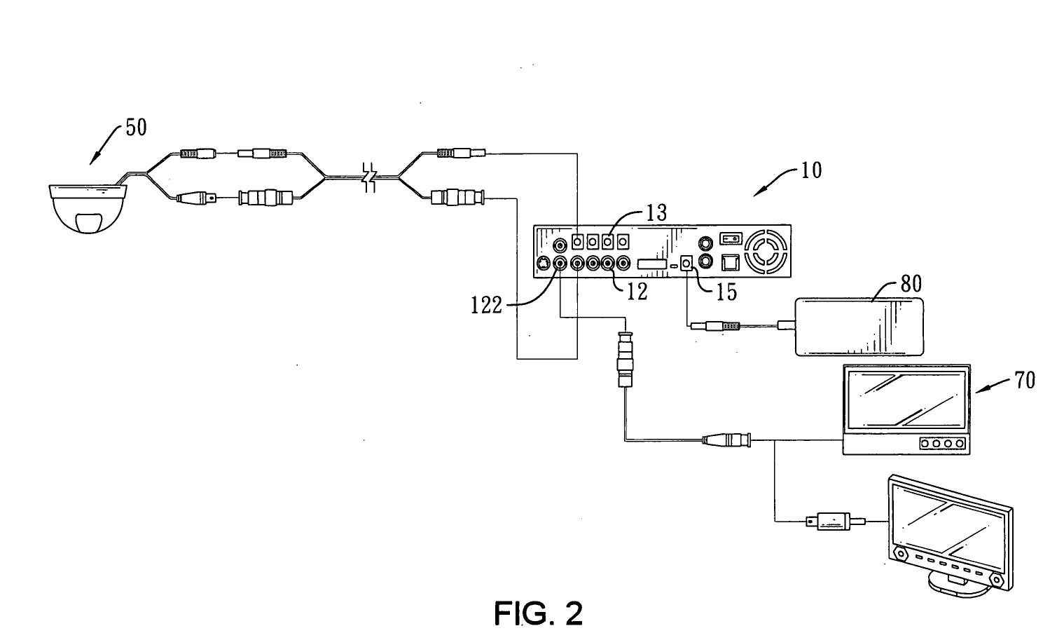

Referring to FIGS. 1 and 2, the signal jacks (12,122) are attached to the casing (11), and the circuit board (16) is mounted inside the casing (11) and is electrically connected to the signal jacks (12,122). The signal jacks (12,122) are connected respectively to multiple cameras (50) and at least one monitor (70) to receive video signals sent from the cameras and send signals to the monitors (70) to allow a user to monitor multiple locations.

The power supply circuit (14) is mounted on the circuit board (16) and is electrically to an exterior electrical power (80). The power supply circuit (14) comprises an AC (alternating current) to DC (direct current) power transformer to transform an alternating current (AC) power provided by the exterior electrical power (80) to a direct current (DC) power. The power jacks (13) are attached to the casing (11) and electrically connected to the power supply circuit (14) on the circuit board (16).

With such an arrangement, the cameras (50) connected to the signal jacks (12,122) can be connected to the powerjacks (13) through cables, such that the power supply circuit (14) can provide electrical power to the connected cameras (50) through the power jacks (13). Therefore, external power supplies for providing electrical power to the cameras (50) are not needed, so to set a video system with the digital video recorder (10) is convenient and the cost for arranging the video system is low.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A digital video recorder adapted to connect to multiple cameras and comprising:
a casing;
multiple signal jacks attached to the casing and adapted to connect to the cameras to receive video signals from the cameras;
a circuit board mounted inside the casing and electrically connected to the signal jacks;
a power supply circuit mounted on the circuit board; and
multiple powerjacks attached to the casing, electrically connected to the power supply circuit on the circuit board and adapted to connect to the cameras to provide electrical power to the connected cameras.

2. The digital video recorder as claimed in claim 1, wherein the power supply circuit is adapted to connect to an exterior electrical power and comprises an AC (alternating current) to DC (direct current) power transformer.
